(19) United States
(12) Patent Application Publication
(10) Pub. No.: US 2026/0289399 A1
(43) Pub. Date: Sep. 24, 2026

(54) METHOD AND SYSTEM FOR ENSURING TRUST IN ARTIFICIAL INTELLIGENCE (AI) AGENT OPERATIONS

(71) Applicant: LTI Mindtree Ltd, Mumbai (IN)

(72) Inventors: Pradeep T, Mumbai (IN); Ranganath Ramakrishna, Mumbai (IN)

(21) Appl. No.: 19/342,737

(22) Filed: Sep. 29, 2025

(30) Foreign Application Priority Data
Mar. 19, 2025 (IN) 202521024548

(51) Int. Cl. G06N 20/00

(52) U.S. Cl. CPC G06N 20/00

(57) ABSTRACT

A method and system for ensuring trust in AI agent operations is disclosed. The system receives input data and performs input evaluation using predefined trust metrics to generate a set of input trust scores that are transmitted to an agent administrator interface. Upon receiving an approval signal via the agent administrator interface, the system forwards the input data to the AI agent. The system receives an output data generated by the AI agent, and performs validation of the output data using an optimal validation source selected from a hierarchical arrangement of validation sources. The validation source selection progresses through the hierarchical arrangement based on data availability. The system generates a set of output trust scores and transmits them to the agent administrator interface to facilitate determining whether to accept the output data.

### FIELD

Various embodiments of the present disclosure generally relate to Artificial Intelligence (AI) agents. More particularly, the disclosure relates to a method and system for ensuring trust in AI agent operations by providing trust scores based on evaluation of input data intended for the AI agent and validation of output data generated by the AI agent.

### BACKGROUND

Agentic AI refers to artificial intelligence systems designed to operate autonomously, making decisions and taking actions based on input data, learned patterns, and predefined objectives. The AI agents can perform complex tasks, adapt to dynamic environments, and improve their performance over time without requiring continuous human oversight. Their ability to function independently enables automation across various domains, including healthcare, finance, cybersecurity, and customer service.

However, as AI agents become more autonomous, ensuring trust in their operations is essential. Trust in AI is influenced by factors such as transparency, reliability, fairness, and accountability. Users and stakeholders must have confidence that the AI agent's decisions are based on valid reasoning, free from biases, and aligned with expected outcomes.

Moreover, in the current landscape, users often struggle to understand the operations of AI agentic services. The lack of visibility into how these AI agents process data, make decisions, and generate outputs creates a significant trust gap between users and AI systems. When users cannot ascertain whether an AI agent's actions are based on sound reasoning, ethical principles, or unbiased data, they become hesitant to rely on its decisions. This trust deficit not only affects user adoption but also exposes developers and organizations to legal, financial, and reputational risks. If an AI agent produces an incorrect, biased, or harmful outcome, the absence of transparency makes it difficult to determine accountability, leading to potential liability issues. Developers and service providers may be held responsible for AI-driven errors, particularly in sectors with strict regulatory and ethical requirements, such as healthcare, finance, and law enforcement.

Building on this, it is well known that AI agents, particularly those leveraging complex models such as deep learning and reinforcement learning, operate as black boxes. The models process vast amounts of data and make decisions based on intricate mathematical computations that are often difficult for humans to interpret. As a result, users who rely on AI agents without a clear understanding of how decisions are made are naturally hesitant to trust their outcomes. The lack of transparency in AI decision-making is a critical issue, especially in high-stakes applications where explainability is essential for compliance, accountability, and ethical considerations. Users, whether individuals or organizations, need to understand the rationale behind an AI agent's decision to evaluate its reliability and fairness. However, existing solutions fail to provide explanations in a human-readable format, making it challenging to validate AI-generated results.

Currently, AI agents are expected to make decisions that align with human values, societal norms, and ethical guidelines. However, while these systems are designed for efficiency and optimization, there is no existing mechanism to evaluate whether their decisions are morally acceptable. AI agents primarily focus on achieving predefined objectives, often prioritizing data-driven efficiency over ethical considerations. This lack of moral oversight can lead to scenarios where AI agents make technically correct but ethically questionable decisions. For instance, an AI-driven recruitment system might optimize candidate selection based on historical data but inadvertently reinforce biases against certain demographic groups. Similarly, an autonomous financial advisory system might recommend cost-saving measures that maximize profits but disregard social responsibility or long-term ethical concerns.

Furthermore, AI agents are not immune to errors and, in some cases, may cause unintended harm. Despite their advanced capabilities, these systems can make mistakes due to biases in training data, limitations in model generalization, or unforeseen edge cases. When such failures occur, determining responsibility becomes a significant challenge. Existing systems lack dedicated mechanisms for attributing accountability, whether from a legal, operational, or ethical standpoint. In traditional software systems, responsibility for errors can often be traced back to specific code faults, developers, or system configurations. However, AI agents operate with a degree of autonomy, making decisions based on probabilistic models rather than deterministic rules. This complexity blurs the lines of accountability—should the blame fall on the developers, the organization deploying the AI, the data sources used for training, or even the end-user?

Furthermore, governments and industries worldwide are increasingly implementing regulations to govern the use of agentic AI, aiming to ensure safety, fairness, and accountability. As AI systems become more autonomous and integral to decision-making across various sectors, regulatory bodies are mandating stricter compliance measures to mitigate risks associated with bias, discrimination, privacy violations, and unethical decision-making. Despite these growing regulatory efforts, existing AI systems lack built-in mechanisms to align their decision-making processes with both local and global legal frameworks. AI agents operate based on data-driven models, which may not inherently account for jurisdiction-specific laws, industry guidelines, or ethical constraints. This misalignment can lead to legal violations, non-compliance penalties, and reputational risks for organizations deploying AI-driven solutions.

Furthermore, existing solutions lack a comprehensive mechanism to validate input data provided to an AI agent, verify the accuracy and reliability of its output, and incorporate contextual understanding to establish trust in automated processes. AI agents rely heavily on the quality and integrity of input data to generate meaningful outcomes, yet current systems do not offer a structured approach to assess whether the data fed into these models is accurate, unbiased, or contextually appropriate. Similarly, once an AI agent produces an output, there is no standard method to verify its correctness, consistency, or alignment with real-world conditions. Many AI models function as black boxes, making it difficult to trace the reasoning behind their outputs or detect potential errors. This lack of verification not only reduces confidence in AI-driven decisions but also increases the risk of deploying unreliable or biased results in critical applications such as finance, healthcare, or legal services.

Considering the aforementioned challenges, there is a need for a technically effective solution that can systematically assess AI agent operations, ensuring that their decision-making processes are transparent, explainable, and aligned with ethical, legal, and operational standards. As agentic AI continues to play an increasingly autonomous role in various domains, it is imperative to establish mechanisms that allow users to understand, trust, and verify AI-generated decisions.

### SUMMARY

The present disclosure provides a method and system for ensuring trust in AI agent operations. The system receives an input data intended for an AI agent and performs input evaluation on the input data using a plurality of predefined trust metrics to generate a set of input trust scores. The plurality of predefined trust metrics comprise a set of lexical metrics, and a set of harmlessness metrics. The set of input trust scores are transmitted to an agent administrator interface. Upon receiving an approval signal via the agent administrator interface, the system forwards the input data to the AI agent for processing. The system receives an output data generated by the AI agent in response to the input data, and performs validation of the output data using an optimal validation source selected from a hierarchical arrangement of validation sources comprising a ground truth reference data, an external knowledge fabric metadata, and agent confidence indicators. The validation source selection progresses through the hierarchical arrangement based on data availability.

The system then generates a set of output trust scores based on the validation such as response-based metrics, inference metrics, honesty metrics, and helpfulness metrics. The set of output trust metrics are then transmitted to the agent administrator interface to facilitate informed decision regarding whether to accept the output data.

### BRIEF DESCRIPTION OF THE FIGURES

FIG. 1 is a diagram that illustrates an exemplary environment within which various embodiments of the present disclosure may function.

FIG. 2 is a diagram that illustrates a system for ensuring trust in AI agent operations, in accordance with an embodiment of the disclosure.

FIG. 3 is a diagram that illustrates an overview of the system performing operations to monitor interactions to and from an AI agent, in accordance with an exemplary embodiment of the disclosure.

FIG. 4 is a diagram that illustrates a method for ensuring trust in AI agent operations, in accordance with an embodiment of the disclosure.

### DETAILED DESCRIPTION

The present disclosure provides a method and system for ensuring trust in AI agent operations. The system receives an input data intended for an AI agent and performs input evaluation on the input data using a plurality of predefined trust metrics to generate a set of input trust scores. The plurality of predefined trust metrics comprise a set of lexical metrics, and a set of harmlessness metrics. The set of input trust scores are transmitted to an agent administrator interface. Upon receiving an approval signal via the agent administrator interface, the system forwards the input data to the AI agent for processing. The system receives an output data generated by the AI agent in response to the input data, and performs validation of the output data using an optimal validation source selected from a hierarchical arrangement of validation sources comprising a ground truth reference data, an external knowledge fabric metadata, and agent confidence indicators. The validation source selection progresses through the hierarchical arrangement based on data availability. The system then generates a set of output trust scores based on the validation such as response-based metrics, inference metrics, honesty metrics, and helpfulness metrics. The set of output trust metrics are then transmitted to the agent administrator interface to facilitate informed decision regarding whether to accept the output data.

In one or more embodiments, an AI agent refers to an autonomous or semi-autonomous software-based system that processes input data, performs decision-making based on learned patterns, and generates corresponding outputs. AI agents can operate in various domains, including natural language processing, predictive analytics, robotics, financial modeling, healthcare diagnostics, and autonomous systems. The AI agents often rely on advanced machine learning models, such as deep learning and reinforcement learning, to function with minimal human intervention.

In one or more embodiments, trust metrics refer to a set of predefined parameters used to evaluate the reliability, integrity, and contextual relevance of both input data and output data processed by an AI agent. The trust metrics serve as quantitative and qualitative indicators to assess whether the AI agent's operations can be trusted. Trust metrics may include, but are not limited to, data consistency, provenance, bias detection, uncertainty estimation, model confidence, and adherence to ethical or regulatory guidelines.

In one or more embodiments, trust scores refer to quantifiable indicators that represent the reliability, accuracy, and credibility of both input data and output data processed by an AI agent. The trust e scores are derived based on predefined trust metrics, which evaluate various aspects of data integrity, consistency, provenance, bias, uncertainty, and compliance with ethical or regulatory standards. Trust scores serve as a measurable confidence index that enables stakeholders to assess whether an AI agent's operations can be trusted.

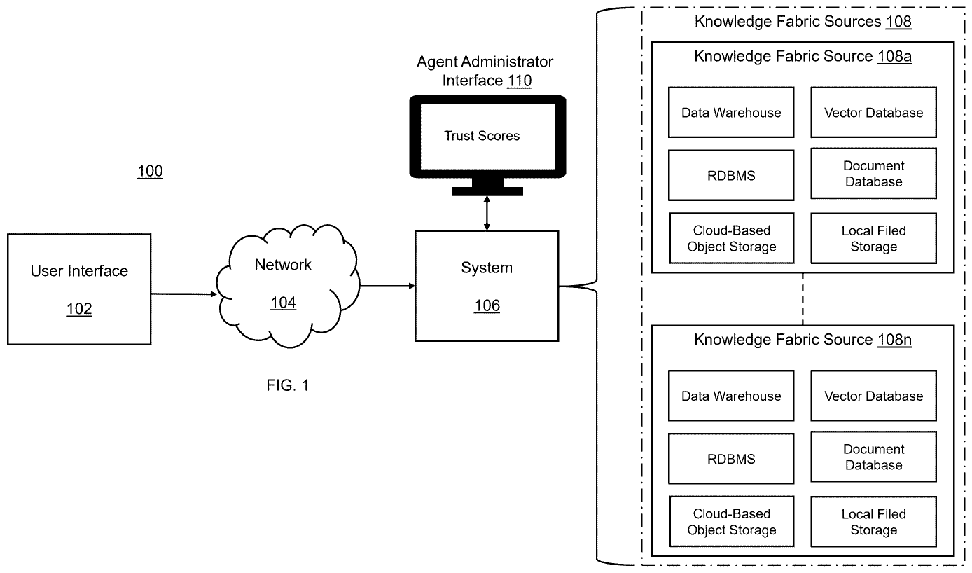

FIG. 1 is a diagram that illustrates an exemplary environment 100 within which various embodiments of the present disclosure may function. Referring to FIG. 1 the environment comprises a user interface 102, a network 104, a system 106, a plurality of knowledge fabric sources 108, and an agent administrator interface 110.

The user interface 102 illustrated in the environment 100 is configured to receive input data from a user. The user interface 102 is configured to receive any type of input data, such as questions, commands, structured or unstructured text, numerical data, images, audio, or any other modality relevant to AI agent operations. Additionally, the user interface 102 may include interactive elements that allow users to provide feedback, modify inputs, or review AI-generated outputs. It may be implemented as a graphical user interface (GUI), a command-line interface (CLI), or a voice-based interface, depending on the application requirements.

In some non-limiting embodiments, the user interface 102 is also configured to receive drag-and-drop type inputs, allowing users to intuitively submit files, documents, images, or other data elements for processing. The drag-and-drop feature may be particularly useful for handling large datasets, batch processing, or submitting multimedia content for AI analysis.

The network 104 facilitates communication between the various components of the environment 100, including the user interface 102, and the system 106. It enables the transfer of data, instructions, and results between the different modules and the system 106, allowing for seamless evaluation of trust in AI agent operations. The network 104 may comprise various communication protocols, such as local area networks (LAN), wide area networks (WAN), or the internet.

The system 106 offers a dual-mode evaluation mechanism that assesses both the input data for its suitability for processing by the AI agent and the output data generated by the AI agent to ensure compliance with specific trust metrics before any further actions are taken.

For input data evaluation, the system 106 analyzes various properties such as completeness, consistency, authenticity, and bias, generating corresponding input evaluation metric values. These metric values provide a structured assessment of the input data's quality and reliability. The generated input evaluation metrics are then presented to an agent administrator, who reviews the assessment and determines whether to allow the input data to proceed to the AI agent for processing.

For output data evaluation, the system 106 assesses the AI-generated output based on trustworthiness indicators, such as alignment with ground truth references, external knowledge validation, and internal confidence scores. The system 106 generates output evaluation metric values, which are then returned to the agent administrator. This enables the agent administrator to decide whether to accept the AI agent's output for further analysis, refine the input for reprocessing, or reject the output due to potential inaccuracies or inconsistencies.

In addition to trust evaluation, the system 106 incorporates contextual understanding to build trust in automated processes. By analyzing the broader context surrounding both input and output data, the system 106 ensures that AI agent operations are not only accurate but also aligned with real-world scenarios and user expectations. The system 106 emphasizes fairness by mitigating biases in AI decision-making, ensuring that outputs do not disproportionately favor or disadvantage specific groups. It enhances explainability by providing human-readable justifications for AI-generated outcomes, enabling users and administrators to understand the reasoning behind AI decisions. Furthermore, the system 106 supports adaptability, allowing AI agents to adjust decision-making processes based on evolving regulations, domain-specific requirements, or user feedback.

The plurality of knowledge fabric sources 108 serves as a diverse data repository network, so that the system 106 has access to a wide spectrum of structured, semi-structured, and unstructured data. Each knowledge fabric source 108a . . . 108n is developed and maintained by different organizations, allowing the system 106 to aggregate, process, and analyze data from heterogeneous sources to generate reliable insights.

In one or more embodiments, the plurality of knowledge fabric sources 108 are dynamically queried, indexed, and processed by the system 106 based on user inputs. The system 106 employs data retrieval, semantic analysis, and metadata indexing so that relevant knowledge is extracted efficiently.

In one or more embodiments, the types of data storage systems described herein, including structured data warehouses, vector databases, relational database management systems (RDBMS), document databases, cloud-based object storage, and local file storage, are provided merely as examples and should not be construed as limiting. The system 106 is designed to interface with a wide range of data storage architectures, and additional types of storage mechanisms may be incorporated without deviating from the scope of the disclosure.

For example, the system 106 may further integrate with graph databases for relationship-based data modeling, time-series databases for handling temporal data streams, blockchain-based storage for decentralized data integrity, key-value stores for high-performance lookup operations, or distributed file systems for scalable parallel processing.

The agent administrator interface 110 is configured to present the set of output trust scores generated by the system 106, providing an assessment of the AI agent's decision reliability. Alongside these trust scores, the agent administrator interface 110 also showcases a plurality of actionable insights, which may include explanations of trust score calculations, potential risks, recommendations for improving data quality, and alternative validation sources.

In an exemplary embodiment, the agent administrator interface 110 can be any type of visual interface, such as a computer monitor, a touchscreen display, a mobile device screen, an augmented reality (AR) interface, or a head-mounted display. The agent administrator interface 110 may also include interactive elements, such as graphical user interface (GUI) components, dashboards, or visualization tools that allow the agent administrator to explore trust scores, validation sources, and actionable insights in a dynamic manner.

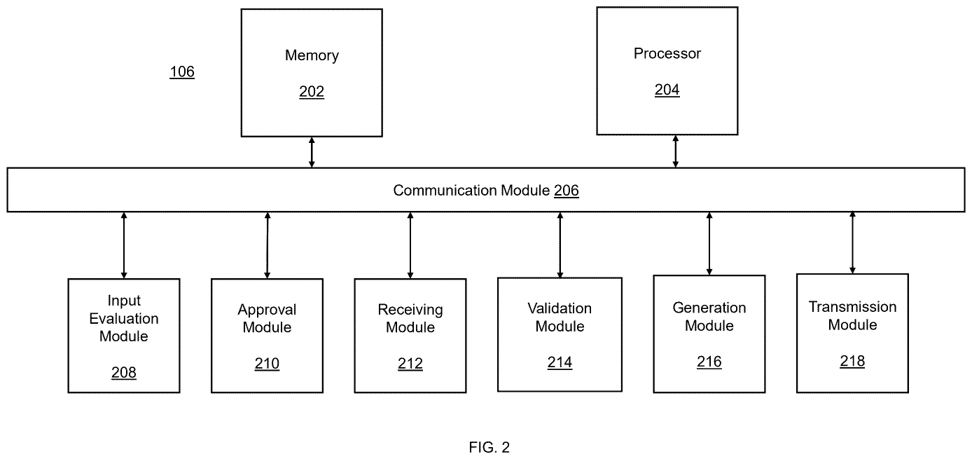

FIG. 2 is a diagram that illustrates a system 106 for ensuring trust in AI agent operations, in accordance with an embodiment of the disclosure. Referring to FIG. 2, the system 106 comprises a memory 202, a processor 204, a communication module 206, an input evaluation module 208, an approval module 210, a receiving module 212, a validation module 214, a generation module 216, and a transmission module 218.

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

The system 106 initially receives input data intended for an AI agent via the user interface 102. The user interface 102 enables various types of input, including text-based queries, voice commands, or drag-and-drop files, ensuring flexibility in user interaction. The received input data is then processed by the system 106 to assess its quality, suitability, and compliance before being forwarded to the AI agent for execution. Wherein the input data can be a query, a command, a request for information, a dataset for analysis, or any other form of structured or unstructured data that requires processing by the AI agent.

Upon receiving the input data, the input evaluation module 208, which comprises dedicated logic, code, and interfaces, is configured to perform a structured evaluation using a plurality of predefined trust metrics to generate a set of input trust scores. The set of input trust scores quantify the reliability, appropriateness, and safety of the input data before it is sent for processing. The input evaluation ensures that the AI agent only operates on data that meets established trustworthiness criteria, thereby reducing the risk of erroneous, harmful, or misleading outputs.

In one or more embodiments, the predefined trust metrics for input evaluation are categorized into lexical metrics and harmlessness metrics, each serving a distinct role in assessing the integrity and trustworthiness of the input.

In one or more embodiments, the lexical metrics focus on the linguistic and structural properties of the input data. The lexical metrics evaluate how readable, interpretable, and well-formed the input is, ensuring that it is suitable for processing by the AI agent. The lexical metrics include, but are not limited to:
Sentiment Analysis: This metric determines the emotional tone of the input text. It classifies the input as positive, negative, or neutral based on sentiment-bearing words and phrases. For example, legal or factual queries should ideally be neutral, whereas excessive negativity might indicate biased framing.
Reading Ease Assessment: This evaluates how easily the input text can be understood by different user groups. The system 106 can use well-known readability measures (e.g., the Flesch Reading Ease score) to determine if the input is suitable for general users or requires domain-specific expertise to interpret.
Readability Index Calculation: The Flesch-Kincaid readability score, among other indices, quantifies text complexity based on word and sentence structure. A lower score indicates higher difficulty, which may require rephrasing to improve AI processing accuracy.
Syllable Counting: This metric counts the number of syllables in words to estimate linguistic difficulty. Longer words with more syllables tend to increase processing complexity, affecting readability and AI comprehension.
Lexicon Counting: The system 106 analyzes the variety and complexity of words used in the input. A high lexical diversity suggests a rich and varied vocabulary, while a low count may indicate oversimplification or redundancy.
Sentence Counting: This metric counts the number of sentences in the input to assess text coherence and completeness. Fragmented inputs with too few sentences may lack context, while overly long sentences can introduce ambiguity.
Character Counting: This determines the total number of characters in the input to check for excessive brevity or verbosity. An input with very few characters might be too vague, whereas a lengthy input could introduce unnecessary complexity.
Polysyllable Identification: The system 106 detects words with multiple syllables, as these often indicate technical jargon or complex phrasing. High polysyllable density might suggest that the input is challenging for AI models trained in general-purpose language.
Monosyllable Identification: This analyzes the presence of single-syllable words, which may indicate simplicity and directness. However, excessive monosyllabic usage might lead to oversimplification, reducing the precision of the input.
Difficult Word Detection: The system 106 identifies complex or uncommon words that might impact the interpretability of the input. For example, specialized legal, medical, or technical terms could require additional contextual clarification for accurate AI processing.

In one or more embodiments, the harmlessness metrics, on the other hand, are designed to evaluate the input data for potential risks, ethical concerns, or security threats. The harmlessness metrics help mitigate the possibility of AI misuse or manipulation by detecting malicious or harmful prompts. The harmlessness metrics include:
Jailbreak Similarity Detection: This metric evaluates whether the input resembles known adversarial prompts designed to bypass AI safety mechanisms. Attackers often use specific patterns to override ethical constraints and force the AI agent to generate inappropriate or restricted responses. By comparing inputs against a database of known jailbreak attempts, the system 106 can flag and reject potential exploitation attempts.
Toxicity Measurement: The system 106 assesses whether the input contains offensive, abusive, or harmful language. Using natural language processing (NLP) models trained on toxicity detection, it identifies hateful speech, threats, or inflammatory content, ensuring that AI interactions remain safe and respectful.
Prompt Injection Identification: Attackers may attempt to manipulate the AI's behavior by embedding hidden instructions or deceptive prompts. This metric detects structured adversarial inputs designed to override pre-programmed safeguards, preventing AI from executing unintended actions or revealing sensitive information.
Pattern Recognition: The system 106 analyzes the input for recurring harmful or deceptive patterns commonly associated with manipulative behaviors, such as phishing attempts, misinformation campaigns, or coordinated adversarial attacks. By recognizing these patterns, the AI can mitigate risks before generating a response.
Bias Evaluation: This metric examines whether the input exhibits or promotes biased perspectives. Inputs that are framed in a prejudiced or misleading manner can lead to biased AI outputs. The system 106 evaluates linguistic and contextual factors to ensure that the input is neutral and does not reinforce stereotypes or discrimination.
Fairness Assessment: The system 106 determines whether the input aligns with principles of fairness and neutrality. It checks for loaded language, leading questions, or exclusionary phrasing that might skew the AI's response.

The system 106 is configured to transmit the set of input trust scores, generated by the input evaluation module 208, to an agent administrator interface 110. The agent administrator interface 110 serves as a control panel that provides the administrator with a view of the input evaluation results, enabling real-time monitoring and decision-making regarding the AI agent's operations.

In one or more embodiments, an administrator interacts with the agent administrator interface 110 to review the input trust scores and determine whether the input data should be forwarded to the AI agent for processing. The administrator can assess various trust parameters, including lexical and harmlessness metrics, to evaluate whether the input meets the predefined quality, safety, and ethical standards.

To facilitate this decision-making process, the system 106 incorporates the approval module 210, which comprises suitable logic, software components, and/or interfaces. The approval module 210 is responsible for receiving the administrator's approval signal via the agent administrator interface 110. Upon receiving a positive approval signal, the approval module 210 forwards the input data to the AI agent for processing. Conversely, if the input fails to meet the necessary trustworthiness criteria, the administrator can choose to reject or modify the input before resubmission.

The receiving module 212 may comprise suitable logic, code, and/or interfaces that may be configured to receive an output generated by the AI agent in response to the input data.

In one or more embodiments, the receiving module 212 is further configured to receive or determine an evaluation type selection via the agent administrator interface 110. The evaluation type selection by the agent administrator indicates at least one of ground truth-based evaluation and confidence score-based evaluation.

In one or more embodiments, the evaluation type selection may be configured in two ways such as, (I) the agent administrator actively selects the evaluation type each time an input is processed, or (II) the evaluation type is preconfigured for a particular AI agent at an initial stage, enabling the AI agent to automatically determine the evaluation type for subsequent inputs without requiring manual selection.

In one or more embodiments, the system 106 upon receiving the evaluation type by the receiving module 212, configures the validation of the output data.

The validation module 214 may comprise suitable logic, code, and/or interfaces that may be configured to perform validation of the output data using an optimal validation source selected from a hierarchical arrangement of validation sources comprising a ground truth reference data, an external knowledge fabric metadata, and agent confidence indicators. The validation source selection progresses through the hierarchical arrangement based on data availability.

In one or more embodiments, upon receiving an evaluation type selection indicating ground truth-based validation, the system 106 initiates a validation process to verify the accuracy and reliability of the AI agent's output. The system 106 first determines whether ground truth reference data is available. If such data is present, the system proceeds with ground truth-based validation by directly comparing the AI-generated output with the established ground truth reference data. This validation method ensures a high degree of accuracy, as the output is benchmarked against known correct values.

In one or more embodiments, ground truth reference data serves as a benchmark dataset containing verified, authoritative, and contextually accurate information against which AI-generated outputs can be evaluated. This reference data may be derived from curated datasets, expert-validated records, historical data logs, or domain-specific knowledge bases, depending on the application context. Ground truth data provides a gold standard for assessing the correctness and reliability of AI responses, ensuring that the system's outputs align with pre-established factual, semantic, or operational expectations. By leveraging ground truth-based validation, the system 106 can measure the accuracy, completeness, and contextual integrity of AI-generated outputs, reducing the risk of misinformation or hallucinated responses. Additionally, the dynamic nature of ground truth data allows the system 106 to adapt to evolving knowledge, ensuring continuous refinement and enhancement of AI performance.

In one or more embodiments, the ground truth-based validation comprises calculating at least one similarity metric to assess the alignment between the output data and the ground truth reference data. The similarity metrics may include, but are not limited to:
Semantic Similarity Measurement: This metric evaluates the meaning-based closeness between the output data and the ground truth reference. Instead of comparing exact words, it uses vector-based models or embeddings to determine how semantically similar two texts are. This ensures that paraphrased yet accurate responses are still recognized as valid.
Response Relevance Score: This metric quantifies how contextually appropriate the AI's response is with respect to the input query. Even if the AI produces a grammatically correct sentence, it may still be off-topic or unrelated. The response relevance score ensures that the generated output directly answers the intended query.
Bilingual Evaluation Understudy (BLEU) Score: Commonly used in machine translation, BLEU measures n-gram precision, meaning it checks how many sequences of words in the output match those in the reference text. A higher BLEU score indicates closer alignment with the ground truth, but this metric may not fully capture meaning-based correctness.
Recall-Oriented Understudy for Gisting Evaluation (ROUGE) Score: Frequently applied in text summarization, ROUGE evaluates how much of the reference text is covered by the AI's output. Unlike BLEU, which focuses on precision, ROUGE is recall-based, measuring how well the response retains key phrases and concepts from the ground truth.
Metric for Evaluation of Translation with Explicit Ordering (METEOR) Score: METEOR improves upon BLEU by incorporating synonym matching, stemming, and order flexibility. It balances precision and recall, making it useful for evaluating content where word order and synonyms matter, such as question answering and summarization.
Bidirectional Encoder Representations from Transformers (BERT) Score: Unlike traditional n-gram metrics, BERTScore leverages contextual embeddings from transformer-based models to compare the semantic closeness between the AI's response and the reference text. This approach allows for greater flexibility in evaluating meaning, even when wording differs significantly.
Levenshtein Similarity Ratio: This metric calculates the edit distance—the number of insertions, deletions, or substitutions required to convert one text into another. A smaller edit distance implies a higher textual similarity. While useful for measuring exact textual changes, it may not capture semantic meaning shifts as well as embedding-based metrics like BERTScore.

However, in an alternative embodiment, if the system 106 determines that ground truth reference data is unavailable, it evaluates whether to perform knowledge fabric-based validation. In this approach, the system 106 attempts to retrieve validation metadata from at least one external knowledge fabric source (108a . . . 108n). Upon successfully retrieving the relevant metadata, the system 106 validates the AI-generated output by comparing it with the retrieved knowledge fabric-based reference data. This approach leverages external domain knowledge to establish trust in the AI agent's output, even when direct ground truth references are not available.

In one or more embodiments, the system 106 supports one or more evaluation methods to assess the reliability of AI agent outputs. The evaluation method may be determined based on the availability of token probabilistic values for the generated tokens. One such method is confidence score-based validation, where the system 106 evaluates the AI agent's output using agent confidence indicators. The confidence indicators may include probabilistic estimates, model certainty scores, or reliability assessments derived from prior interactions.

In one or more embodiments, an alternative evaluation method is ground truth-based validation. If the system 106 determines that a ground truth reference is unavailable, it resorts to metadata-based evaluation as a fallback mechanism. Metadata-based evaluation leverages external knowledge fabric metadata to validate the AI agent's response.

One such confidence metric is the prediction confidence score, which quantifies the AI agent's certainty regarding its generated output. The prediction confidence score is typically derived from internal probability distributions, where higher confidence scores indicate that the AI agent is more certain about the correctness of its response, while lower scores suggest ambiguity or potential errors. By evaluating this metric, the system 106 can determine whether the output data meets the required threshold for acceptance.

In one or more embodiments, in addition to the prediction confidence score, the system 106 may perform a log probability calculation for each token in the output data. Log probabilities provide a more granular view of the AI model's decision-making process by indicating how likely each word or token was chosen in the response generation. A lower log probability suggests that the AI model was uncertain about selecting a particular token, which may indicate an unreliable or less accurate response. By aggregating these probabilities across the entire response, the system 106 can assess the overall confidence in the generated output.

In some non-limiting embodiments, another metric used for confidence score-based validation is the Brier score, which measures the accuracy of probabilistic predictions made by the AI agent. The Brier score calculates the squared difference between predicted probability values and the actual outcomes, with lower scores indicating better calibration and more reliable predictions. This metric is especially useful in applications where probabilistic forecasting is involved, ensuring that the AI agent's confidence aligns with the true likelihood of correctness.

Furthermore, the system 106 may evaluate the expected calibration error (ECE), which quantifies the discrepancy between predicted confidence levels and actual correctness. ECE helps identify whether an AI model tends to be overconfident or underconfident in its responses. By analyzing the calibration of predicted probabilities against observed accuracy, the system 106 can determine whether the AI agent's confidence scores are a reliable indicator of performance. This ensures that the AI agent does not provide misleadingly high-confidence responses that are incorrect or low-confidence responses that are actually correct.

The generation module 216 may comprise suitable logic, code, and/or interfaces that may be configured to generate a set of output trust score based on the validation.

In one or more embodiments, the set of output trust scores comprises multiple metrics categorized into different groups, each assessing a distinct aspect of the AI-generated response. These groups include response-based metrics, inference metrics, honesty metrics, and helpfulness metrics, collectively ensuring that the AI agent produces responses that are not only accurate but also reliable, efficient, ethical, and user-friendly.

In one or more embodiments, the response-based metrics focus on evaluating the fundamental properties of the AI-generated response. The response based metrics include lexical assessment, which analyzes the structural and linguistic quality of the response, such as readability, fluency, grammatical correctness, and overall coherence. Additionally, harmlessness evaluation ensures that the output does not contain offensive, biased, or potentially harmful content. This evaluation typically involves checking for toxic language, adversarial patterns, policy violations, and unintended biases that could negatively impact the end user.

The inference metrics assess the computational and operational aspects of generating the response. Computational cost evaluates the resource consumption involved in producing the output, ensuring that responses are generated in a cost-effective manner. Processing latency measures the time taken for the AI agent to generate the response, helping to optimize system performance and ensure real-time responsiveness. Linguistic perplexity assesses how well the AI agent predicts a sequence of words, with lower perplexity values indicating more fluent and coherent responses. Lastly, environmental impact evaluates the energy consumption and carbon footprint associated with generating responses, promoting sustainability in AI operations.

The honesty metrics focus on ensuring that the AI-generated response is truthful and contextually appropriate. Semantic alignment measures how well the response corresponds to the intended meaning and expected answer, reducing the chances of misinterpretation or misleading statements. Contextual relevance ensures that the output remains relevant to the provided input query and does not introduce unrelated or extraneous information. These honesty-focused assessments help establish trust in AI-generated content by minimizing inaccuracies and ensuring factual consistency.

The helpfulness metrics assess whether the response effectively meets the user's needs. Comprehensiveness evaluates whether the response provides sufficient detail and depth, ensuring that it covers all necessary aspects of the user's query. Conciseness measures the efficiency of the response, ensuring that it is not excessively verbose while still delivering complete and meaningful information. Hallucination detection identifies instances where the AI generates misleading or entirely fabricated content, preventing the dissemination of false information. By monitoring these helpfulness metrics, the system 106 ensures that the AI agent provides responses that are both informative and practical for the end user.

The exemplary table 1 and table 2 below illustrates an overview of the set of output trust scores generated by the generation module 216 based on validation. The table provides a structured representation of various trust score metrics categorized under different evaluation aspects.

TABLE 1

| Metric | Metric Sub | | Score | |
|---|---|---|---|---|
| Category | Category | Metric Name | Value | Remarks |
| Response- | Lexical Assessment | Sentiment | Score 0.87 | High readability and |
| Based | | | | well-formed structure |
| | | Reading_ease | Score 0.75 | Moderate readability; |
| | | | | slightly complex |
| | | | | structure |
| | | syllable_count | Score 0.82 | Well-balanced word |
| | | | | complexity |
| | Harmlessness | jailbreak similarity | Score 0.92 | No detected harmful or |
| | Evaluation | | | adversarial content |
| | | toxicity | Score 0.15 | Low toxicity detected, |
| | | | | safe response |
| | | prompt injection | Score 0.08 | Minimal prompt |
| | | | | manipulation detected |
| | Inference Metrics | Latency | 250 ms | Response time within |
| | | | | acceptable range |
| | | Perplexity | 12.5 | Moderate perplexity |
| | | | | indicating coherent text |
| | | Carbon Footprint | 0.02 g CO2 | Low environmental |
| | | | | impact per response |
| | Confidence Score | Prediction | Score 0.89 | High confidence in |
| | Metrics | Confidence | | prediction accuracy |
| | | Log probability of | −2.3 | Moderate token |
| | | each token | | certainty level |
| | | BRIER Score | Score 0.12 | Good calibration of |
| | | | | predicted probabilities |
| | | Expected | Score 0.05 | Minimal deviation from |
| | | Calibration Error | | ideal confidence levels |
| | Interpretation | Interpretation | Score 0.91 | Highly interpretable and |
| | | | | understandable |
| | | | | response |

TABLE 2

| | | | | |
|---|---|---|---|---|
| Ground Truth/ | Honesty Metrics | Semantic Similarity | Score 0.87 | Strong semantic |
| Metadata/Input | | Response Relevance | Score 0.94 | Highly relevant response |
| Based | | | | to input query |
| | | BLEU Score | Score 0.76 | Good alignment with |
| | | | | reference text |
| | | ROUGH Score | Score 0.82 | High similarity in rough |
| | | | | text structure |
| | | METEOR Score | Score 0.71 | Moderate alignment |
| | | | | based on precision and |
| | | | | recall |
| | | BERT Score | Score 0.88 | Strong similarity in |
| | | | | contextual embedding |
| | | Levenshtein Similarity | Score 0.85 | High textual similarity |
| | | Ratio | | based on edit distance |
| | Helpfulness | Response | Score 0.93 | Complete response |
| | | Completeness | | addressing all aspects of |
| | | | | input |
| | | Response | Score 0.81 | Concise yet informative |
| | | Conciseness | | response |
| | | Response | Score 0.09 | Minimal hallucinated |
| | | Hallucination Level | | content detected |

In one or more embodiments, the metric names provided in the exemplary table 1 and table 2 above are merely illustrative and should not be considered limiting. The disclosed system 106 is adaptable to incorporate additional trust evaluation metrics beyond those explicitly mentioned. Depending on specific use cases, operational requirements, or advancements in AI trust evaluation methodologies, other relevant metrics may be included to enhance the assessment of input and output trust scores.

The transmission module 218 may comprise dedicated logic, code, and/or interfaces that may be configured to transmit the set of output trust scores to the agent administrator interface 110 to facilitate a determination of whether to accept the output data.

In one or more embodiments, the agent administrator reviews the set of output trust scores provided to the agent administrator interface 110 and takes an informed decision whether or not the AI agent can be given the input data for processing, and the output data generated by the AI agent can be accepted or not.

The system 106 is also configured to continuously monitor interactions between itself and the AI agent, ensuring transparency, accountability, and regulatory compliance throughout the AI-driven decision-making process.

To facilitate this, the system 106 maintains an audit record that captures a structured history of interactions. This audit record includes, but is not limited to, the input data submitted by the user, the set of input trust scores generated by the input evaluation module 208, the output data produced by the AI agent, the set of output trust scores generated by the generation module 216, and the administrative decisions taken in response to these evaluations.

By storing the input data, the system 106 ensures that there is a verifiable record of all user-submitted queries, prompts, or commands. This is crucial for tracking user intent, analyzing trends in system usage, and troubleshooting potential issues related to input formulation. Furthermore, storing the set of input trust scores allows the system 106 to retrospectively examine how the input data was assessed before being processed by the AI agent. Since these scores reflect various trust parameters such as lexical properties, readability, sentiment, and harmlessness, they provide valuable insights into the initial risk assessment performed before the AI model engages with the input.

Similarly, the output data generated by the AI agent is archived in the audit record to establish a reference point for evaluating AI-generated responses over time. This is essential for understanding system behavior, identifying patterns of incorrect or biased responses, and refining model performance based on historical outputs. Accompanying this data, the set of output trust scores offers a granular assessment of response quality, capturing various metrics related to lexical assessment, inference performance, honesty, and helpfulness.

Additionally, the administrative decisions made by human reviewers or automated governance mechanisms are recorded in the audit log, providing a clear account of how input and output evaluations influenced system 106 actions. These decisions may include whether a particular input was accepted or rejected based on input trust scores, whether an AI-generated response was deemed trustworthy for further use, and whether any corrective actions were taken in response to detected anomalies.

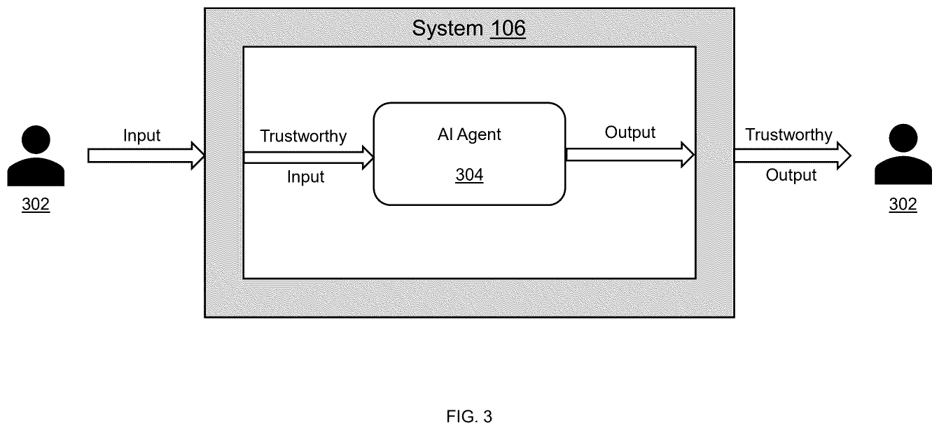

FIG. 3 is a diagram 300 that illustrates an overview of the system 106 performing operations to monitor interactions to and from an AI agent 304, in accordance with an exemplary embodiment of the present disclosure. Referring to FIG. 3, the diagram 300 comprises a user 302, the AI agent 304, and the system 106.

In this exemplary implementation, consider the user 302 interacting with the AI agent 304 to generate an executive summary of a legal document. The user submits the following input via a user interface 102:
Summarize the attached legal contract and highlight any clauses that could lead to potential disputes.

Upon receiving the input, the input evaluation module 208 analyzes the trustworthiness of the user's request using predefined lexical and harmlessness metrics.

### Lexical Assessment Output:

Sentiment: Neutral
Readability Score (Flesch-Kincaid): 38 (Difficult to read)
Complexity Metrics:
   Word count: 250
   Syllable count: 800
   Polysyllabic word ratio: 40%

### Harmlessness Evaluation Output:

Bias detection: No bias detected
Toxicity measurement: 0.02 (Safe)
Prompt injection risk: None

The system 106 assigns an input trust score of 85/100 based on these evaluations.

The transmission module 218 sends the trust score to the agent administrator interface 110, where the agent administrator reviews the trustworthiness of the request.

The approval module 210 provides the agent administrator with options to either approve, reject, or modify the input. Given the high input trust score, the administrator approves the input, and the system 106 forwards it to the AI agent 304 for processing.

The AI agent 304 processes the input and generates the following summary:
The contract primarily outlines service-level agreements, payment terms, and liability clauses. Notable clauses include:
   Clause 12.3, which states that termination requires a 90-day notice period, and Clause 15.7, which indemnifies the service provider against indirect damages. These clauses could be potential points of dispute.

The validation module 214 determines the best method to validate the output. The system 106 first checks for ground truth-based validation by searching a legal contract database. No exact reference is found, so it proceeds with knowledge fabric-based validation, querying a legal clause repository.

Validation Results from Knowledge Fabric:
Clause 12.3 (Termination Notice): Matches industry standard (V)
Clause 15.7 (Indemnification): Slight deviation from standard practices

### Confidence Score-Based Validation Results:

Prediction confidence score: 92%
Log probability of key terms: High (Reliable)
Expected calibration error: Low (0.03)

The system 106 assigns an output trust score of 78/100 and flags Clause 15.7 as a potential risk.

The transmission module 218 sends the output trust scores and validation insights to the agent administrator interface 110. The administrator reviews the information and takes the following action:
Decision: Forward the AI-generated summary to the legal team for further review, with a note highlighting the flagged indemnification clause.

The system 106 stores an audit record containing:
1. Input data: User query
2. Input trust scores: 85/100
3. AI-generated output: Summary of legal contract
4. Output trust scores: 78/100
5. Administrative decision: Forwarded to legal team with flagged clause

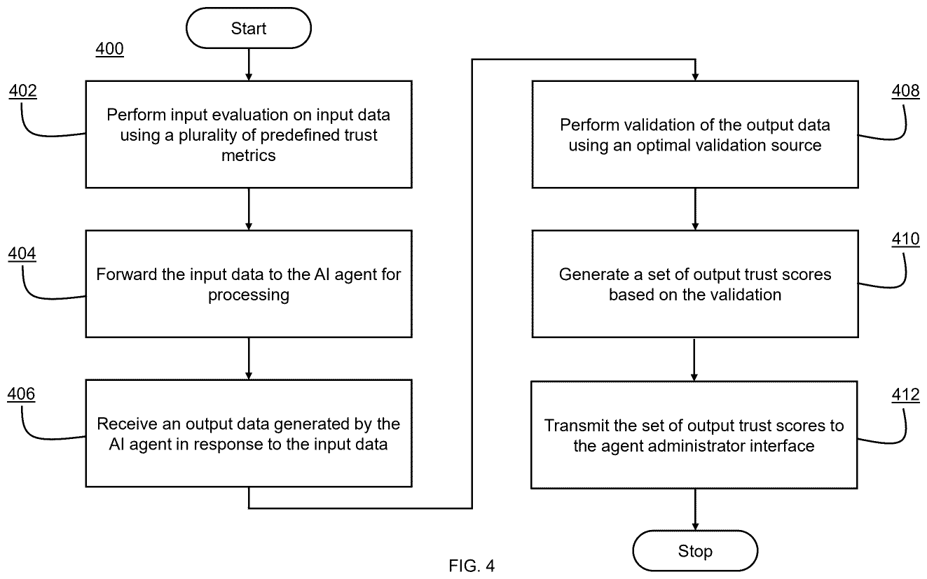

FIG. 4 is a diagram that illustrates a flowchart 400 for a method for ensuring trust in AI agent operations, in accordance with an embodiment of the present disclosure.

The system 106 initially receives input data intended for an AI agent via the user interface 102. The user interface 102 enables various types of input, including text-based queries, voice commands, or drag-and-drop files, ensuring flexibility in user interaction. The received input data is then processed by the system 106 to assess its quality, suitability, and compliance before being forwarded to the AI agent for execution.

At 402, input evaluation on the input data is performed by the input evaluation module 208 using a plurality of predefined trust metrics to generate a set of input trust scores. The set of input trust scores quantify the reliability, appropriateness, and safety of the input data before it is sent for processing. The input evaluation ensures that the AI agent only operates on data that meets established trustworthiness criteria, thereby reducing the risk of erroneous, harmful, or misleading outputs.

In one or more embodiments, the predefined trust metrics for input evaluation are categorized into lexical metrics and harmlessness metrics, each serving a distinct role in assessing the integrity and trustworthiness of the input.

In one or more embodiments, the lexical metrics focus on the linguistic and structural properties of the input data. The lexical metrics evaluate how readable, interpretable, and well-formed the input is, ensuring that it is suitable for processing by the AI agent.

In one or more embodiments, the harmlessness metrics, on the other hand, are designed to evaluate the input data for potential risks, ethical concerns, or security threats. The harmlessness metrics help mitigate the possibility of AI misuse or manipulation by detecting malicious or harmful prompts.

At 404, the approval module 210 forwards the input data to the AI agent for processing, upon receiving an approval signal via the agent administrator interface 110. The agent administrator interface 1108 serves as a control panel that provides the administrator with a view of the input evaluation results, enabling real-time monitoring and decision-making regarding the AI agent's operations.

In one or more embodiments, an administrator interacts with the agent administrator interface 110 to review the input trust scores and determine whether the input data should be forwarded to the AI agent for processing. The administrator can assess various trust parameters, including lexical and harmlessness metrics, to evaluate whether the input meets the predefined quality, safety, and ethical standards. By presenting a structured breakdown of the trust scores, the system ensures transparency and empowers the administrator to make informed decisions regarding data acceptance or rejection.

To facilitate this decision-making process, the system 106 incorporates the approval module 210, which comprises suitable logic, software components, and/or interfaces. The approval module 210 is responsible for receiving the administrator's approval signal via the agent administrator interface 110. Upon receiving a positive approval signal, the approval module 210 forwards the input data to the AI agent for processing. Conversely, if the input fails to meet the necessary trustworthiness criteria, the administrator can choose to reject or modify the input before resubmission.

At 406, an output generated by the AI agent is received by the receiving module 212, in response to the input data.

In one or more embodiments, the receiving module 212 is further configured to receive or determine an evaluation type selection via the agent administrator interface 110. The evaluation type selection by the agent administrator indicates at least one of ground truth-based evaluation and confidence score-based evaluation.

In one or more embodiments, the evaluation type selection may be configured in two ways such as, (I) the agent administrator actively selects the evaluation type each time an input is processed, or (II) the evaluation type is preconfigured for a particular AI agent at an initial stage, enabling the AI agent to automatically determine the evaluation type for subsequent inputs without requiring manual selection.

In one or more embodiments, the system 106 upon receiving the evaluation type by the receiving module 212, configures the validation of the output data.

At 408, the validation module 214 performs validation of the output data using an optimal validation source selected from a hierarchical arrangement of validation sources comprising a ground truth reference data, an external knowledge fabric metadata, and agent confidence indicators.

The validation source selection progresses through the hierarchical arrangement based on data availability.

In one or more embodiments, upon receiving an evaluation type selection indicating ground truth-based validation, the system 106 initiates a validation process to verify the accuracy and reliability of the AI agent's output. The system 106 first determines whether ground truth reference data is available. If such data is present, the system 106 proceeds with ground truth-based validation by directly comparing the AI-generated output with the established ground truth reference data. This validation method ensures a high degree of accuracy, as the output is benchmarked against known correct values.

In one or more embodiments, ground truth reference data serves as a benchmark dataset containing verified, authoritative, and contextually accurate information against which AI-generated outputs can be evaluated. This reference data may be derived from curated datasets, expert-validated records, historical data logs, or domain-specific knowledge bases, depending on the application context. Ground truth data provides a gold standard for assessing the correctness and reliability of AI responses, ensuring that the system's outputs align with pre-established factual, semantic, or operational expectations. By leveraging ground truth-based validation, the system 106 can measure the accuracy, completeness, and contextual integrity of AI-generated outputs, reducing the risk of misinformation or hallucinated responses. Additionally, the dynamic nature of ground truth data allows the system 106 to adapt to evolving knowledge, ensuring continuous refinement and enhancement of AI performance.

In one or more embodiments, the ground truth-based validation comprises calculating at least one similarity metric to assess the alignment between the output data and the ground truth reference data.

However, in an alternative embodiment, if the system 106 determines that ground truth reference data is unavailable, it evaluates whether to perform knowledge fabric-based validation. In this approach, the system 106 attempts to retrieve validation metadata from at least one external knowledge fabric source (108a . . . 108n). Upon successfully retrieving the relevant metadata, the system 106 validates the AI-generated output by comparing it with the retrieved knowledge fabric-based reference data. This approach leverages external domain knowledge to establish trust in the AI agent's output, even when direct ground truth references are not available.

In one or more embodiments, the system 106 supports one or more evaluation methods to assess the reliability of AI agent outputs. The evaluation method may be determined based on the availability of token probabilistic values for the generated tokens. One such method is confidence score-based validation, where the system 106 evaluates the AI agent's output using agent confidence indicators. The confidence indicators may include probabilistic estimates, model certainty scores, or reliability assessments derived from prior interactions.

In one or more embodiments, an alternative evaluation method is ground truth-based validation. If the system 106 determines that a ground truth reference is unavailable, it resorts to metadata-based evaluation as a fallback mechanism. Metadata-based evaluation leverages external knowledge fabric metadata to validate the AI agent's response.

One such confidence metric is the prediction confidence score, which quantifies the AI agent's certainty regarding its generated output. The prediction confidence score is typically derived from internal probability distributions, where higher confidence scores indicate that the AI agent is more certain about the correctness of its response, while lower scores suggest ambiguity or potential errors. By evaluating this metric, the system 106 can determine whether the output data meets the required threshold for acceptance.

In one or more embodiments, in addition to the prediction confidence score, the system 106 may perform a log probability calculation for each token in the output data. Log probabilities provide a more granular view of the AI model's decision-making process by indicating how likely each word or token was chosen in the response generation. A lower log probability suggests that the AI model was uncertain about selecting a particular token, which may indicate an unreliable or less accurate response. By aggregating these probabilities across the entire response, the system 106 can assess the overall confidence in the generated output.

In some non-limiting embodiments, another metric used for confidence score-based validation is the Brier score, which measures the accuracy of probabilistic predictions made by the AI agent. The Brier score calculates the squared difference between predicted probability values and the actual outcomes, with lower scores indicating better calibration and more reliable predictions. This metric is especially useful in applications where probabilistic forecasting is involved, ensuring that the AI agent's confidence aligns with the true likelihood of correctness.

Furthermore, the system 106 may evaluate the expected calibration error (ECE), which quantifies the discrepancy between predicted confidence levels and actual correctness. ECE helps identify whether an AI model tends to be overconfident or underconfident in its responses. By analyzing the calibration of predicted probabilities against observed accuracy, the system 106 can determine whether the AI agent's confidence scores are a reliable indicator of performance. This ensures that the AI agent does not provide misleadingly high-confidence responses that are incorrect or low-confidence responses that are actually correct.

At 410, a set of output trust scores based on the validation are generated by the generation module 216.

In one or more embodiments, the set of output trust scores comprises multiple metrics categorized into different groups, each assessing a distinct aspect of the AI-generated response. These groups include response-based metrics, inference metrics, honesty metrics, and helpfulness metrics, collectively ensuring that the AI agent produces responses that are not only accurate but also reliable, efficient, ethical, and user-friendly.

In one or more embodiments, the response-based metrics focus on evaluating the fundamental properties of the AI-generated response. The response based metrics include lexical assessment, which analyzes the structural and linguistic quality of the response, such as readability, fluency, grammatical correctness, and overall coherence. Additionally, harmlessness evaluation ensures that the output does not contain offensive, biased, or potentially harmful content. This evaluation typically involves checking for toxic language, adversarial patterns, policy violations, and unintended biases that could negatively impact the end user.

The inference metrics assess the computational and operational aspects of generating the response. Computational cost evaluates the resource consumption involved in producing the output, ensuring that responses are generated in a cost-effective manner. Processing latency measures the time taken for the AI agent to generate the response, helping to optimize system performance and ensure real-time responsiveness. Linguistic perplexity assesses how well the AI agent predicts a sequence of words, with lower perplexity values indicating more fluent and coherent responses. Lastly, environmental impact evaluates the energy consumption and carbon footprint associated with generating responses, promoting sustainability in AI operations.

The honesty metrics focus on ensuring that the AI-generated response is truthful and contextually appropriate. Semantic alignment measures how well the response corresponds to the intended meaning and expected answer, reducing the chances of misinterpretation or misleading statements. Contextual relevance ensures that the output remains relevant to the provided input query and does not introduce unrelated or extraneous information. These honesty-focused assessments help establish trust in AI-generated content by minimizing inaccuracies and ensuring factual consistency.

The helpfulness metrics assess whether the response effectively meets the user's needs. Comprehensiveness evaluates whether the response provides sufficient detail and depth, ensuring that it covers all necessary aspects of the user's query. Conciseness measures the efficiency of the response, ensuring that it is not excessively verbose while still delivering complete and meaningful information. Hallucination detection identifies instances where the AI generates misleading or entirely fabricated content, preventing the dissemination of false information. By monitoring these helpfulness metrics, the system 106 ensures that the AI agent provides responses that are both informative and practical for the end user.

At 412, the transmission module 218 transmits the set of output trust scores to the agent administrator interface to facilitate a determination of whether to accept the output data.

In one or more embodiments, the agent administrator reviews the set of output trust scores provided to the agent administrator interface 110 and takes an informed decision whether or not the AI agent can be given the input data for processing, and the output data generated by the AI agent can be accepted or not.

The system 106 is also configured to continuously monitor interactions between itself and the AI agent, ensuring transparency, accountability, and regulatory compliance throughout the AI-driven decision-making process. This monitoring function plays a crucial role in maintaining the integrity and reliability of the AI system by systematically recording all exchanges between the AI agent and various components of the system.

To facilitate this, the system 106 maintains an audit record that captures a structured history of interactions. This audit record includes, but is not limited to, the input data submitted by the user, the set of input trust scores generated by the input evaluation module 208, the output data produced by the AI agent, the set of output trust scores generated by the generation module 216, and the administrative decisions taken in response to these evaluations.

By storing the input data, the system 106 ensures that there is a verifiable record of all user-submitted queries, prompts, or commands. This is crucial for tracking user intent, analyzing trends in system usage, and troubleshooting potential issues related to input formulation. Furthermore, storing the set of input trust scores allows the system 106 to retrospectively examine how the input data was assessed before being processed by the AI agent. Since these scores reflect various trust parameters such as lexical properties, readability, sentiment, and harmlessness, they provide valuable insights into the initial risk assessment performed before the AI model engages with the input.

Similarly, the output data generated by the AI agent is archived in the audit record to establish a reference point for evaluating AI-generated responses over time. This is essential for understanding system behavior, identifying patterns of incorrect or biased responses, and refining model performance based on historical outputs. Accompanying this data, the set of output trust scores offers a granular assessment of response quality, capturing various metrics related to lexical assessment, inference performance, honesty, and helpfulness. By preserving these scores, the system 106 ensures that every AI-generated response can be analyzed in depth to assess its reliability, coherence, and overall suitability for end-user consumption.

Additionally, the administrative decisions made by human reviewers or automated governance mechanisms are recorded in the audit log, providing a clear account of how input and output evaluations influenced system 106 actions. These decisions may include whether a particular input was accepted or rejected based on input trust scores, whether an AI-generated response was deemed trustworthy for further use, and whether any corrective actions were taken in response to detected anomalies.

The method and system is advantageous in that it introduces a technically advanced validation framework that ensures transparency, reliability, and trustworthiness in AI-driven decision-making, particularly in the Agentic AI Era. Unlike prior approaches that rely on static validation techniques, the system implements a multi-faceted evaluation process that not only validates input data and verifies AI-generated outputs but also integrates contextual awareness to enhance decision-making accuracy.

A key advantage over conventional systems is its dynamic adaptability, enabling real-time assessment of AI outputs based on evolving trust parameters. By leveraging a multi-layered trust scoring mechanism, the system provides quantifiable confidence levels, ensuring that AI decisions align with ethical standards and application-specific constraints. Moreover, the system's emphasis on fairness, explainability, and robustness mitigates biases and prevents adversarial manipulation, thereby fostering responsible AI adoption.

The disclosed system introduces a clear bifurcation between input and output evaluation, a significant technical enhancement over prior methodologies that often treat AI validation as a monolithic process. By distinctly assessing input data before processing and output data after generation, the system ensures that each phase is independently optimized, leading to a more granular and precise trust assessment.

The input evaluation module of the system applies lexical, harmlessness, and structural assessments to detect ambiguities, adversarial inputs, or biases before they influence AI processing. This preemptive filtering ensures that only high-quality, contextually relevant inputs proceed to the AI agent, thereby reducing the likelihood of error propagation.

Conversely, the generation module employs semantic similarity, coherence analysis, and factual verification to assess AI-generated content. This ensures that the output not only meets accuracy standards but also aligns with expected contextual and ethical guidelines. By isolating these evaluation phases, the system enhances reliability, minimizes cascading errors, and strengthens trust in AI-driven decision-making across diverse applications.

The introduction of Knowledge Fabric-based evaluation represents a key advancement that significantly enhances the system's adaptability and intelligence in handling AI validation. Unlike conventional validation approaches that rely solely on predefined ground truth reference data, this method enables the system to dynamically retrieve contextual metadata from external Knowledge Fabric sources when explicit ground truth data is unavailable.

By leveraging structured data warehouses, vector databases, relational databases, document stores, and cloud-based knowledge repositories, the system can contextualize and validate AI-generated outputs against relevant domain-specific information. This capability ensures that the system remains resilient in real-world applications, where exhaustive ground truth datasets may not always be present.

Furthermore, the Knowledge Fabric-based evaluation supports adaptive learning, allowing the system to continuously improve its validation processes by integrating new, authoritative sources over time. This makes it particularly effective in evolving fields such as legal analysis, scientific research, and dynamic market intelligence, where knowledge is constantly expanding and must be continuously cross-referenced for optimal decision-making.

The generated evaluation metrics serve as a critical decision-making tool for the agent owner by directly influencing whether to accept or reject the AI agent's output. Unlike conventional AI evaluation frameworks that offer opaque or generic performance indicators, this system provides granular, interpretable, and context-specific trust scores that translate into actionable insights.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for ensuring trust in artificial intelligence (AI) agent operations, the system comprising:
a processor;
a memory storing instructions that, when executed by the processor, cause the processor to:
receive an input data intended for an AI agent;
perform input evaluation on the input data using a plurality of predefined trust metrics to generate a set of input trust scores;
transmit the set of input trust scores to an agent administrator interface;
upon receiving an approval signal via the agent administrator interface, forward the input data to the AI agent for processing;
receive an output data generated by the AI agent in response to the input data;
perform validation of the output data using an optimal validation source selected from a hierarchical arrangement of validation sources comprising a ground truth reference data, an external knowledge fabric metadata, and agent confidence indicators, wherein the validation source selection progresses through the hierarchical arrangement based on data availability;
generate a set of output trust scores based on the validation; and
transmit the set of output trust scores to the agent administrator interface to facilitate a determination of whether to accept the output data.

2. The system of claim 1, wherein the plurality of predefined trust metrics for input evaluation comprises:
a set of lexical metrics comprising at least one of a sentiment analysis, a reading ease assessment, a readability index calculation, a syllable counting, a lexicon counting, a sentence counting, a character counting, a polysyllable identification, a monosyllable identification, and a difficult word detection; and
a set of harmlessness metrics comprising at least one of a jailbreak similarity detection, a toxicity measurement, a prompt injection identification, a pattern recognition, a bias evaluation, and a fairness assessment.

3. The system of claim 1, wherein the processor is further configured to:
receive an evaluation type selection via the agent administrator interface, the evaluation type selection indicating at least one of ground truth-based evaluation and confidence score-based evaluation; and
configure the validation of the output data based on the received evaluation type selection.

4. The system of claim 3, wherein when the evaluation type selection indicates ground truth-based validation, to perform validation of the output data, the possessor is configured to:
determine whether ground truth reference data is available;
when the ground truth reference data is available, perform the ground truth-based validation by comparing the output data with the ground truth reference data; and
when the ground truth reference data is unavailable, determine whether to perform knowledge fabric-based validation.

5. The system of claim 4, wherein when knowledge fabric-based validation is to be performed, to perform validation of the output data, the processor is further configured to:
attempt to retrieve validation metadata from at least one external knowledge fabric source;
upon successfully retrieving the validation metadata, perform the knowledge fabric-based validation by comparing the output data with the retrieved validation metadata; and
upon failure to retrieve the validation metadata or upon determining not to perform knowledge fabric-based validation, perform confidence score-based validation using the agent confidence indicators.

6. The system of claim 5, wherein the at least one external knowledge fabric source comprises at least one of a structured data warehouse, a vector database, a relational database management system, a document database, cloud-based object storage, and local file storage.

7. The system of claim 4, wherein the ground truth-based validation comprises calculating at least one similarity metric selected from:
a semantic similarity measurement between the output data and the ground truth reference data;
a response relevance score;
a Bilingual Evaluation Understudy (BLEU) score;
a Recall-Oriented Understudy for Gisting Evaluation (ROUGE) score;
a Metric for Evaluation of Translation with Explicit Ordering (METEOR) score;
a Bidirectional Encoder Representations from Transformers (BERT) score; and
a Levenshtein similarity ratio.

8. The system of claim 5, wherein the confidence score-based validation comprises evaluating at least one confidence metric selected from:
a prediction confidence score indicating a level of certainty assigned by the AI agent to the output data;
a log probability calculation for each token in the output data;
a Brier score measuring accuracy of probabilistic predictions; and
an expected calibration error measuring the difference between predicted probabilities and actual outcomes.

9. The system of claim 1, wherein the set of output trust scores comprises metrics categorized into groups comprising:
response-based metrics comprising lexical assessment and harmlessness evaluation;
inference metrics comprising computational cost, processing latency, linguistic perplexity, and environmental impact;
honesty metrics comprising semantic alignment and contextual relevance; and
helpfulness metrics comprising comprehensiveness, conciseness, and hallucination detection.

10. The system of claim 1, wherein the processor is further configured to:
monitor interactions between the system and the AI agent; and
maintain an audit record comprising the input data, the set of input trust scores, the output data, the set of output trust scores, and administrative decisions.

11. A computer-implemented method for ensuring trust in artificial intelligence (AI) agent operations, the method is configured to:
receive an input data intended for an AI agent;
perform input evaluation on the input data using a plurality of predefined trust metrics to generate a set of input trust scores;
transmit the set of input trust scores to an agent administrator interface;
upon receiving an approval signal via the agent administrator interface, forward the input data to the AI agent for processing;
receive an output data generated by the AI agent in response to the input data;
perform validation of the output data using an optimal validation source selected from a hierarchical arrangement of validation sources comprising a ground truth reference data, an external knowledge fabric metadata, and agent confidence indicators, wherein the validation source selection progresses through the hierarchical arrangement based on data availability;
generate a set of output trust scores based on the validation; and
transmit the set of output trust scores to the agent administrator interface to facilitate a determination of whether to accept the output data.

12. The computer-implemented method of claim 11, wherein the plurality of predefined trust metrics for input evaluation comprises:
a set of lexical metrics comprising at least one of a sentiment analysis, a reading ease assessment, a readability index calculation, a syllable counting, a lexicon counting, a sentence counting, a character counting, a polysyllable identification, a monosyllable identification, and a difficult word detection; and
a set of harmlessness metrics comprising at least one of a jailbreak similarity detection, a toxicity measurement, a prompt injection identification, a pattern recognition, a bias evaluation, and a fairness assessment.

13. The computer-implemented method of claim 11 is further configured to:
receive an evaluation type selection via the agent administrator interface, the evaluation type selection indicating at least one of ground truth-based evaluation and confidence score-based evaluation; and
configure the validation of the output data based on the received evaluation type selection.

14. The computer-implemented method of claim 13, wherein when the evaluation type selection indicates ground truth-based validation, performing validation of the output data comprises:
determining whether ground truth reference data is available;
when the ground truth reference data is available, performing the ground truth-based validation by comparing the output data with the ground truth reference data; and
when the ground truth reference data is unavailable, determine whether to perform knowledge fabric-based validation.

15. The computer-implemented method of claim 14, wherein when knowledge fabric-based validation is to be performed, performing validation of the output data comprises:
attempting to retrieve validation metadata from at least one external knowledge fabric source;
upon successfully retrieving the validation metadata, performing the knowledge fabric-based validation by comparing the output data with the retrieved validation metadata; and
upon failure to retrieve the validation metadata or upon determining not to perform knowledge fabric-based validation, performing confidence score-based validation using the agent confidence indicators.

16. The computer-implemented method of claim 15, wherein the at least one external knowledge fabric source comprises at least one of a structured data warehouse, a vector database, a relational database management system, a document database, cloud-based object storage, and local file storage.

17. The computer-implemented method of claim 14, wherein the ground truth-based validation comprises calculating at least one similarity metric selected from:
a semantic similarity measurement between the output data and the ground truth reference data;
a response relevance score;
a Bilingual Evaluation Understudy (BLEU) score;
a Recall-Oriented Understudy for Gisting Evaluation (ROUGE) score;
a Metric for Evaluation of Translation with Explicit Ordering (METEOR) score;
a Bidirectional Encoder Representations from Transformers (BERT) score; and
a Levenshtein similarity ratio.

18. The computer-implemented method of claim 15, wherein the confidence score-based validation comprises evaluating at least one confidence metric selected from:
a prediction confidence score indicating a level of certainty assigned by the AI agent to the output data;
a log probability calculation for each token in the output data;
a Brier score measuring accuracy of probabilistic predictions; and
an expected calibration error measuring the difference between predicted probabilities and actual outcomes.

19. The computer-implemented method of claim 11, wherein the set of output trust scores comprises metrics categorized into groups including:
response-based metrics comprising lexical assessment and harmlessness evaluation;
inference metrics comprising computational cost, processing latency, linguistic perplexity, and environmental impact;
honesty metrics comprising semantic alignment and contextual relevance; and
helpfulness metrics comprising comprehensiveness, conciseness, and hallucination detection.

20. The computer-implemented method of claim 11 further comprising:
monitoring interactions between the system and the AI agent; and
maintaining an audit record comprising the input data, the set of input trust scores, the output data, the set of output trust scores, and administrative decisions.
